(19) United States
(12) Patent Application Publication
(10) Pub. No.: US 2021/0186293 A1
(43) Pub. Date: Jun. 24, 2021

(54) Robot Cleaner and Method For Controlling The Same

(71) Applicant: EVERYBOT INC., Seongnam-si (KR)

(72) Inventors: Woo Chul JUNG, Seongnam-si (KR); Sung Hee SHIN, Gimpo-si (KR); Tae Wan KIM, Incheon (KR)

(21) Appl. No.: 17/115,439

(22) Filed: Dec. 8, 2020

(30) Foreign Application Priority Data
Dec. 24, 2019 (KR) 10-2019-0174199

(51) Int. Cl. A47L 11/40; A47L 11/282

(52) U.S. Cl. CPC A47L 11/4066; A47L 11/282; A47L 11/4061; A47L 2201/022; A47L 11/4038; A47L 2201/04; A47L 11/4011

(57) ABSTRACT

Provided are a robot cleaner and a method of controlling the same. The robot cleaner includes a main body, a driver included in the main body and supplying power for driving the robot cleaner to travel, first, second, and third rotation members that are rotated around first, second, and third rotation axes, respectively, using power of the driver and to which cleaners for wet cleaning of a cleaning target surface are fixedly installed, respectively, and a controller controlling at least one of a rotation direction or a rotation speed of the third rotation member to adjust a travel direction of the robot cleaner, wherein the third rotation axis is parallel to a perpendicular direction of the robot cleaner.

### CROSS-REFERENCE TO RELATED APPLICATIONS

The present application claims priority to Korean Patent Application No. 10-2019-0174199, filed on Dec. 24, 2019, the entire contents of which is incorporated herein for all purposes by this reference.

### TECHNICAL FIELD

The present disclosure relates to a robot cleaner and a method of controlling the same.

### BACKGROUND ART

Since industrial technologies have been developed, various devices have been automated. As is well known, a robot cleaner has been used as an apparatus for automatically cleaning an area to be cleaned by absorbing a foreign substance such as dust from a cleaning target surface and wiping a foreign substance from the cleaning target surface while autonomously traveling around the area to be cleaned without manipulation of a user.

In general, the robot cleaner includes a vacuum cleaner for cleaning using suction force from a power source, such as electricity.

The robot cleaner including a vacuum cleaner has a limit in removing a foreign substance, ingrained dirt, or the like fixed to a cleaning target surface, and thus, recently, a robot cleaner having a mop for wet cleaning has come to the fore.

However, a wet cleaning using a general robot cleaner is merely a simple method of attaching a mop to a bottom surface of a conventional robot cleaner for vacuuming, and thus, has a disadvantage in that an effect of removing a foreign substance is low and wet cleaning is not effectively performed.

In particular, in the case of a wet cleaning using a general robot cleaner, the robot cleaner travels using a conventional moving method for a suction-type vacuum cleaner and a conventional avoiding method with respect to an obstacle without change, and thus, there is a problem in that it is difficult to easily remove foreign substances fixed to a cleaning target surface even if dust spread on a cleaning target surface is removed.

In the case of a general structure in which a mop is attached to a robot cleaner, friction force with respect to a bottom surface is high due to a mop surface and separate driving force for moving a wheel is further required, and thus, there is a problem in that a battery consumption is increased.

### DISCLOSURE

### Technical Problem

An object of the present disclosure is to provide a robot cleaner and a method of controlling the same for performing wet cleaning while the robot cleaner travels by using rotary power of a plurality of rotation members as a movement force source of the robot cleaner and fixedly installing a cleaner for wet cleaning to a rotation member.

Another object is to provide a robot cleaner including three rotation members and a method of controlling the robot cleaner for specifying and performing an effective corresponding operation in response to a situation that occurs during travel using one of the three rotation members as a device for determining a travel direction.

### Technical Solution

According to an aspect of the present disclosure, there is provided a robot cleaner including a main body, a driver included in the main body and supplying power for driving the robot cleaner to travel, first, second, and third rotation members that are rotated around first, second, and third rotation axes, respectively, using power of the driver and to which cleaners for wet cleaning of a cleaning target surface are fixedly installed, respectively, and a controller controlling at least one of a rotation direction or a rotation speed of the third rotation member to adjust a travel direction of the robot cleaner, wherein the third rotation axis is parallel to a perpendicular direction of the robot cleaner.

The first and second rotation axes may be inclined at a predetermined angle with respect to a central axis parallel to a perpendicular axis of the robot cleaner to externally incline the first and second rotation members in a downward direction based on the central axis.

When the cleaners for wet cleaning are fixed to the first and second rotation members, respectively, the robot cleaner may travel using friction force between each of the fixed cleaners and the cleaning target surface, which is generated due to a rotary motion of each of the fixed cleaners, as a movement force source.

The first rotation axis and the second rotation axis may be symmetrical to each other with respect to a first plane containing the central axis, and the third rotation axis is contained in the first plane.

The controller may control at least one of the rotation direction or the rotation speed of the third rotation member based on information on a load applied to at least one of the first and second rotation members.

The controller may determine a rotation direction of the third rotation member as a direction in which a value of a load applied to a rotation member having a greater difference obtained by subtracting a reference value from the value of the applied load than a remaining rotation member is reduced among the first and second rotation members.

The robot cleaner may further include a detector included in the main body and detecting a state in which the robot cleaner is adjacent to an external object.

When the detector detects a state in which the robot cleaner is adjacent to a drop zone or an external charger supplying power to the robot cleaner, the controller may control at least one of the rotation direction or the rotation speed of the third rotation member to rotate the robot cleaner on the spot.

When the detector detects a state in which the robot cleaner is adjacent to an obstacle, the controller may control at least one of the rotation direction or the rotation speed of the third rotation member to allow the robot cleaner to travel along a trajectory containing a curve having a predetermined radius of curvature and to avoid the obstacle.

According to another aspect of the present disclosure, there is provided a robot cleaner including a main body, a driver included in the main body and supplying power for driving the robot cleaner to travel, first, second, and third rotation members that are rotated around first, second, and third rotation axes, respectively, using power of the driver and to which cleaners for wet cleaning of a cleaning target surface are fixedly installed, respectively, and a controller controlling the driver to adjust a travel direction of the robot cleaner, wherein an angle between the third rotation axis and a perpendicular axis of the robot cleaner is changed in response to a shape of the cleaning target surface while the robot cleaner travels.

The first and second rotation axes may be inclined at a predetermined angle with respect to a central axis parallel to the perpendicular axis of the robot cleaner to externally incline the first and second rotation members in a downward direction based on the central axis.

The third rotation member may be capable of sliding parallel to a perpendicular direction of the robot cleaner.

The controller may control at least one of the rotation direction or the rotation speed of the third rotation member based on information on a load applied to at least one of the first rotation member or the second rotation member.

The robot cleaner may further include a detector included in the main body and detecting a state in which the robot cleaner is adjacent to an external object, wherein, when the detector detects a state in which the robot cleaner is adjacent to a drop zone or an external charger supplying power to the robot cleaner, the controller may control at least one of the rotation direction or the rotation speed of the third rotation member to rotate the robot cleaner on the spot.

According to another aspect of the present disclosure, there is provided a method of controlling a robot cleaner using rotary power of a plurality of rotation members to which cleaners for wet cleaning of a cleaning target surface are attachable, as a movement force source for travel, the method including driving the robot cleaner to travel by rotating at least one of a first rotation member rotating around a first rotation axis or a second rotation member rotating around a second rotation axis, and adjusting a travel direction of the robot cleaner by controlling at least one of a rotation direction or a rotation speed of a third rotation member rotating around a third rotation axis in response to a state event of the robot cleaner, detected in the driving of the robot cleaner to travel, wherein the third rotation axis is parallel to a perpendicular direction of the robot cleaner, or a surface of the third rotation member, to which the cleaner is fixed, is parallel to the cleaning target surface while the robot cleaner travels.

The driving of the robot cleaner to travel may include detecting a load applied to at least one of the first rotation member or the second rotation member, and the adjusting the travel direction may include controlling at least one of the rotation direction or the rotation speed of the third rotation member to restore the detected load to an acceptance range when an event in which the load gets out of the acceptance range occurs.

The driving of the robot cleaner to travel may include detecting a state in which the robot cleaner is adjacent to an external object, and the adjusting the travel direction may include controlling at least one of the rotation direction or the rotation speed of the third rotation member to rotate the robot cleaner on the spot when an event of detecting a state in which the robot cleaner is adjacent to a drop zone or an external charger supplying power to the robot cleaner occurs in the detecting the state.

The driving of the robot cleaner to travel may include detecting a state in which the robot cleaner is adjacent to an external object, and when an event of detecting a state in which the robot cleaner is adjacent to an obstacle in the detecting the state occurs, at least one of the rotation direction or the rotation speed of the third rotation member may be controlled to allow the robot cleaner to travel along a trajectory containing a curve having a predetermined radius of curvature and to avoid the obstacle.

### DESCRIPTION OF DRAWINGS

FIGS. 1A and 1B are a set of a perspective view and a front view showing an outer appearance of a robot cleaner according to an embodiment of the present disclosure.

FIG. 2 is a block diagram showing a robot cleaner according to an embodiment of the present disclosure.

FIGS. 3A and 3B are a set of a right side view and a bottom view showing an outer appearance of a robot cleaner according to an embodiment of the present disclosure.

FIG. 4 is a diagram showing a travel operation of a robot cleaner according to an embodiment of the present disclosure.

FIGS. 5A and 5B are a set of diagrams showing a rotation operation of a robot cleaner according to an embodiment of the present disclosure.

FIGS. 6A and 6B are a set of diagrams showing an outer appearance and arrangement of a driver of a robot cleaner according to an embodiment of the present disclosure.

FIG. 7 is a diagram showing the arrangement of a detector of a robot cleaner according to an embodiment of the present disclosure.

FIGS. 8A and 8B are a set of diagrams showing an operation of a detector of a robot cleaner according to an embodiment of the present disclosure.

FIGS. 9A-9D are a set of diagrams showing an operation of avoiding a drop zone of a robot cleaner according to an embodiment of the present disclosure.

FIGS. 10A and 10B are a set of diagrams showing an external charger and a charging operation thereof according to an embodiment of the present disclosure.

FIG. 11 is a diagram showing an operation of avoiding an obstacle of a robot cleaner according to an embodiment of the present disclosure.

FIGS. 12A and 12B are a set of diagrams showing an operation of a third rotation member according to an embodiment of the present disclosure.

FIG. 13 is a flowchart showing a method of controlling a robot cleaner according to an embodiment of the present disclosure.

### BEST MODE

In the following description, a principle of the present disclosure will be exemplified. Accordingly, one of ordinary skill in the art could create various devices realizing the principle of the present disclosure and included in the concept and scope of the present disclosure although the devices are not clearly described or illustrated in the specification. It would be understood by one of ordinary skill in the art that any conditional terms and embodiments described in the specification are clearly intended only to understand the concept of the present disclosure and are not limited to embodiments and states that are particularly listed herein in principle.

It should be understood that any detailed description of listing a specific embodiment as well as the principle, the point of view, and embodiments of the present disclosure includes structural and functional equivalents thereof. It should be understood that these equivalents include any device created to perform the same function irrespective of an equivalent, that is, a structure to be created in the future as well as a currently known equivalent.

Accordingly, for example, a block diagram of the specification should be understood to represent a conceptual point of view of an exemplary circuit for specifying the principle of the present disclosure. Similarly, it should be understood that any flowchart, state conversion diagram, and pseudo code are substantially represented in a computer readable medium and represent various processes performed by a computer or a processor irrespective of whether a computer or a processor is clearly illustrated.

Functions of various devices illustrated in drawings including functional blocks representing a processor or a similar concept thereto may be provided using hardware having capability for executing software in relation to appropriate software as well as dedicated hardware. When the functions are provided by the processor, the functions may be provided by a single dedicated processor, a single shared processor, or a plurality of separate processors and some of these may be shared.

It should be understood that clear use of terms proposed as a processor, control, or a similar concept thereto is not interpreted as exclusive use of hardware having capability for executing software and is interpreted as implicitly including digital signal processor (DSP) hardware, and read-only memory (ROM), random-access memory (RAM), and a non-volatile memory for storing software. The terms may also include other well-known or commonly used hardware.

In the appended claims of the specification, a component represented by a device for performing a function described in the detailed description is intended to include any method for performing a function including any type of software including, for example, a combination of circuit devices or firmware/micro codes for performing the function and is coupled to an appropriate circuit for executing the software to perform the function. In the present disclosure defined in the claims, functions provided by variously listed devices are coupled to each other and are coupled to a method cited in the claims, and thus it should be understood that any device for providing the function is equivalent to being recognized from the specification.

The aforementioned objects, features, and advantages are more clearly understood with reference the following detailed description in addition to the accompanying drawings, and thus one of ordinary skill in the art will easily implement the technical idea of the present disclosure. In the description of the present disclosure, certain detailed explanations of related art are omitted when it is deemed that they may unnecessarily obscure the essence of the present disclosure.

Hereinafter, various embodiments of the present disclosure will be described in detail with reference to the accompanying drawings.

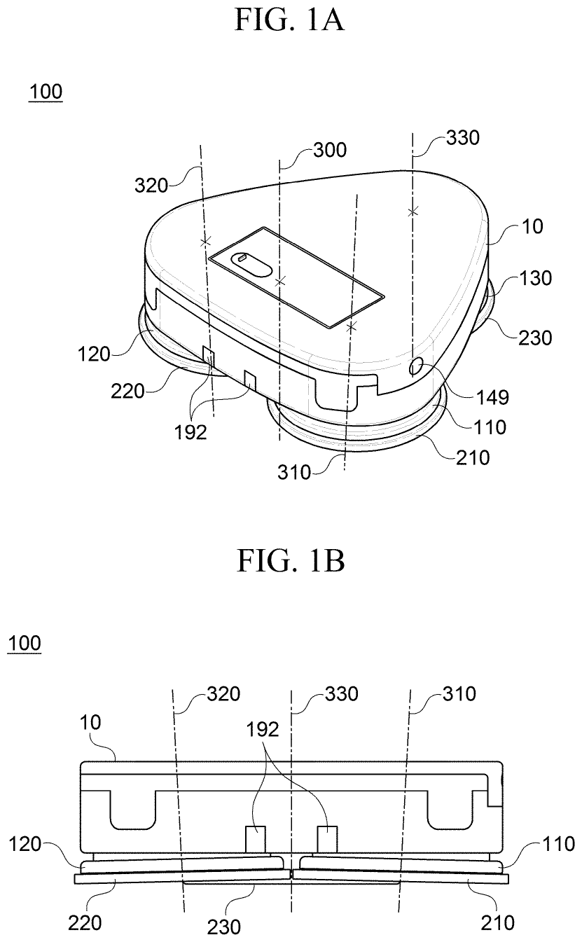

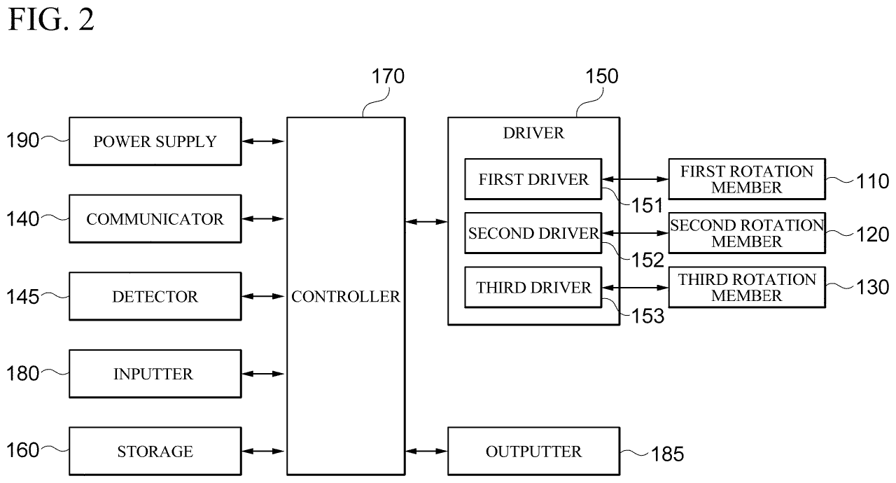

FIGS. 1A and 1B are a set of a perspective view and a front view showing an outer appearance of a robot cleaner according to an embodiment of the present disclosure. FIG. 2 is a block diagram showing a robot cleaner according to an embodiment of the present disclosure.

As shown in FIGS. 1A and 1B and FIG. 2, a robot cleaner 100 according to an embodiment of the present disclosure may include a main body 10, a driver 150, a first rotation member 110, a second rotation member 120, a third rotation member 130, and a controller 170.

Referring to FIG. 2, the robot cleaner 100 according to an embodiment of the present disclosure may further include at least one of a detector 145, a communicator 140, a storage 160, an inputter 180, an outputter 185, or a power supply 190.

The main body 10 may structurally configure the outer appearance of the robot cleaner 100.

In some embodiments, a bumper (not shown) for protecting the main body 10 from external shocks may be formed around an external circumference of the main body 10.

The driver 150 may be included in the main body 10 and may supply power for driving the robot cleaner 100.

Each of the first rotation member 110, the second rotation member 120, and the third rotation member 130 may be rotated around a first rotation axis 310, a second rotation axis 320, and a third rotation axis 330 using power of the driver 150.

The driver 150 may be a component for driving the first rotation member 110, the second rotation member 120, and the third rotation member 130. In more detail, the driver 150 may supply power for rotating and moving the first rotation member 110, the second rotation member 120, and the third rotation member 130 according to control of the controller 170. Here, the driver 150 may include a first driver 151, a second driver 152, and a third driver 153 which drives the first rotation member 110, the second rotation member 120, and the third rotation member 130, respectively, and may include a motor and/or a gear assembly.

A first cleaner 210, a second cleaner 220, and a third cleaner 230 for wet cleaning of a cleaning target surface 900 may be fixed to the first rotation member 110, the second rotation member 120, and the third rotation member 130, respectively.

The robot cleaner 100 may travel while performing wet cleaning using the cleaners 210, 220, and 230. Here, wet cleaning may refer to cleaning for mopping the cleaning target surface 900 using the cleaners 210, 220, and 230 and may include all of, for example, cleaning using a dry mop and cleaning using a mop wet with a liquid.

The first cleaner 210, the second cleaner 220, and the third cleaner 230 may be formed of a material for wiping various cleaning target surfaces, such as a microfiber cloth, a mop, a non-woven fabric, or a brush in order to remove a foreign substance fixed to a bottom surface through a rotary motion. The first cleaner 210, the second cleaner 220, and the third cleaner 230 may have a circular shape as shown in FIGS. 1A and 1B, but may be configured in various forms without being limited to any particular shape.

The first, second, and third cleaners 210, 220, and 230 may be fixed by covering the corresponding rotation members 110, 120, and 130, respectively, or may be fixed using a separate attaching device. For example, the first cleaner 210, the second cleaner 220, and the third cleaner 230 may be fixedly attached to a first fixing member 112 and a second fixing member 122 through a velcro tape or the like.

The robot cleaner 100 according to an embodiment of the present disclosure may remove foreign substances fixed to a bottom surface through friction with the cleaning target surface 900 as the first cleaner 210, the second cleaner 220, and the third cleaner 230 that are rotated through a rotary motion of the first rotation member 110, the second rotation member 120, and the third rotation member 130.

When friction force between the cleaners 210, 220, and 230 and the cleaning target surface 900 is generated, the friction force may be used as a movement force source of the robot cleaner 100.

In more detail, the robot cleaner 100 according to an embodiment of the present disclosure may generate friction force of the first rotation member 110 and the second rotation member 120 with the cleaning target surface 900 as the first rotation member 110 and the second rotation member 120 that are rotated, and a moving speed and direction of the robot cleaner 100 may be adjusted depending on the size of the resultant force and a direction in which the resultant force is applied.

The controller 170 may control the driver 150 to make the robot cleaner travel in a travel direction.

The controller 170 may control the driver 150 to adjust the travel direction of the robot cleaner 100.

The controller 170 may control at least one of a rotation direction or a rotation speed of at least one of the first driver 151 or the second driver 152 to make the robot cleaner 100 travel in a travel direction.

The detector 145 may detect various pieces of information required for an operation of the robot cleaner 100 and may transmit a detection signal to the controller 170.

The communicator 140 may include one or more modules for enabling wireless communication between the robot cleaner 100 and another wireless terminal or between the robot cleaner 100 and a network in which another wireless terminal is positioned. For example, the communicator 140 may communicate with a wireless terminal as a remote control device, and to this end, may include a short-distance communication module, a wireless Internet module, or the like.

An operating state or an operating method of the robot cleaner 100 may be controlled according to a control signal received by the communicator 140. A terminal for controlling the robot cleaner 100 may include, for example, a smart phone, a tablet, a personal computer, or a remote control device, which is communicable with the robot cleaner 100.

The storage 160 may store a program for an operation of the controller 170 and may also temporarily store input/output data. The storage 160 may include at least one type of storage medium of a flash memory type memory, a hard disk type memory, a multimedia card micro type memory, a card type memory (e.g., an SD or XD memory), random access memory (RAM), static random access memory (SRAM), read-only memory (ROM), electrically erasable programmable read-only memory (EEPROM), programmable read-only memory (PROM), a magnetic memory, a magnetic disk, or an optical disk.

The inputter 180 may receive user input for manipulating the robot cleaner 100. In particular, the inputter 180 may receive user input for selecting an operation mode of the robot cleaner 100.

Here, the inputter 180 may include a key pad, a dome switch, a touchpad (resistive/capacitive), a jog wheel, a jog switch, or the like.

The outputter 185 may generate visual or audible output, and may include a display, a sound output module, an alarm unit, and the like although not shown in the drawing.

The display may display (output) information processed by the robot cleaner 100. For example, the display may display a user interface (UI) or a graphic user interface (GUI) for displaying a cleaning time, a cleaning method, a cleaning area, and the like related to a cleaning mode while the robot cleaner performs cleaning.

The power supply 190 may supply power to the robot cleaner 100. In detail, the power supply 190 may supply power to functional components included in the robot cleaner 100, and when the remaining power is insufficient, the power supply 190 may be charged by receiving charging current from an external charger 191. Here, the power supply 190 may be embodied as a chargeable battery.

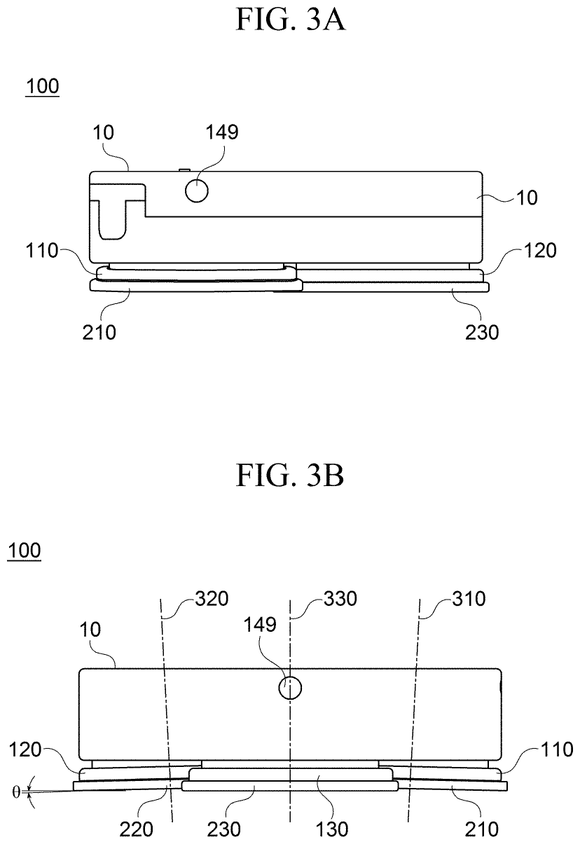

FIGS. 3A and 3B are a set of a right side view and a bottom view showing an outer appearance of a robot cleaner according to an embodiment of the present disclosure.

As shown in FIG. 3B, the first rotation axis 310 and the second rotation axis 320 of the robot cleaner 100 according to an embodiment of the present disclosure may be inclined at a predetermined angle with respect to a central axis 300 in such a way that the first rotation member 110 and the second rotation member 120 are externally inclined in a downward direction (“0” of FIG. 3B) based on the central axis 300 parallel to a perpendicular direction of the robot cleaner 100.

According to an embodiment of the present disclosure, the third rotation axis 330 may be parallel to a perpendicular axis of the robot cleaner 100.

The term “parallel” may be interpreted as “substantially parallel or parallel within an error range”. The term “parallel” used in other parts of the specification may have the same meaning.

According to an embodiment of the present disclosure, the third rotation member 130 may be disposed behind the first and second rotation members 110 and 120 in the robot cleaner 100, and thus when the robot cleaner 100 travels forwards, the third rotation member 130 may follow behind the first and second rotation members 110 and 120.

According to another embodiment of the present disclosure, the third rotation member 130 may be disposed ahead the first and second rotation members 110 and 120 in the robot cleaner 100, and thus when the robot cleaner 100 travels forwards, the third rotation member 130 may lead in front the first and second rotation members 110 and 120.

When the cleaners 210, 220, and 230 are attached to the rotation members 110, 120, and 130, respectively, the third cleaner 230 attached to the third rotation member 130 may cover and clean a region of the cleaning target surface 900, which corresponds to a portion between the first cleaner 210 and the second cleaner 220 and is often skipped to be cleaned while the robot cleaner 100 travels. Accordingly, it may be possible to clear a dead zone of cleaning.

According to an embodiment of the present disclosure, the first rotation axis 310 and the second rotation axis 320 may be symmetrical to each other with respect to a plane (not shown) containing the central axis 300, and the third rotation axis 330 may be contained in the plane (not shown).

The terms “symmetric” and “contained in a plane” may be interpreted as being “substantially or within an error range”. Hereinafter, the terms used in the specification may have the same meaning.

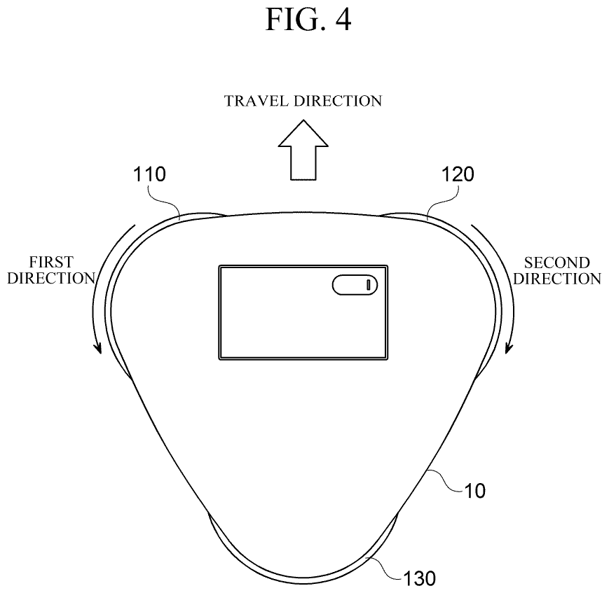

FIG. 4 is a diagram showing a travel operation of a robot cleaner according to an embodiment of the present disclosure.

The robot cleaner 100 according to an embodiment of the present disclosure may travel using friction force between the cleaning target surface 900 and each of the fixed cleaners 210 and 220 as a movement force source, which is generated due to a rotary motion of each of the cleaners 210 and 220 when the cleaners 210 and 220 for wet cleaning are fixed to the first rotation member 110 and the second rotation member 120, respectively.

Referring to FIG. 4, the robot cleaner 100 according to an embodiment of the present disclosure may generate relative movement force from friction force and may travel in a travel direction by rotating the first rotation member 110 in a first direction and rotating the second rotation member 120 in a second direction that is different from the first direction.

When the robot cleaner 100 travels straight while rotating the third rotation member 130, the first and second rotation members 110 and 120 may be rotated in opposite rotation directions and may have different rotation speeds, and an effect of rotating the main body 10 due to a difference therebetween may be compensated for and removed by rotating the third rotation member 130.

According to an embodiment, the robot cleaner 100 may be balanced in the right and left directions by controlling the first rotation member 110 to rotate at a speed x in a counter clockwise direction, controlling the second rotation member 120 to rotate at a speed ax (where 0.5≤a<1) in a clockwise direction, and controlling the third rotation member 130 at a speed (1−a)x in a clockwise direction. The x may not refer to the maximum speed to be obtained by the driver 150 and may be adjusted according to the specification of a rotation motor (not shown) included in the driver 150. In addition, the value 0.5 may not be absolutely unchangeable and may be changed and set to any one of values less than 1.

As necessary, sway of the robot cleaner 100 may be prevented while the robot cleaner 100 travels by increasing and reducing the rotation speed of the third rotation member 130.

According to another embodiment, the rotation speed of the third rotation member 130 may be fixed to ax (where 0<a<1) and the rotation speed of the first and second rotation members 110 and 120 may be determined based on information measured by an inertial measurement unit (not shown). The rotation directions of the first and second rotation members 110 and 120 may be opposite. In this case, a rotation speed of one of the first and second rotation members 110 and 120, which is rotated in an opposite direction to the third rotation member 130, may be set to x, a rotation speed of the other may be set to x(1−a).

In addition, sway of the robot cleaner 100 may also be prevented while the robot cleaner 100 travels by increasing and reducing the rotation speed of the other based on a measured value of the inertial measurement unit (not shown).

According to an embodiment of the present disclosure, the controller 170 may control at least one of the rotation direction or the rotation speed of the third rotation member 130 to adjust a travel direction of the robot cleaner 100.

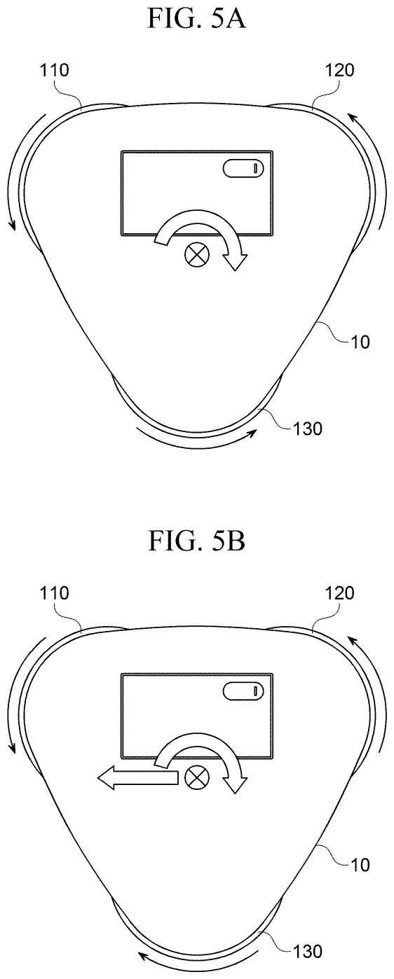

FIGS. 5A and 5B are a set of diagrams showing a rotation operation of a robot cleaner according to an embodiment of the present disclosure.

As shown in FIG. 5A, when all of the first, second, and third rotation members 110, 120, and 130 are rotated in the same direction (direction CCW of FIG. 5A), the main body 10 of the robot cleaner 100 may be rotated in an opposite direction thereto due to overall reaction. In this case, the center of rotation (‘\textcircled{x}’ of FIG. 5A) of the main body 10 may be moving depending on the rotation speed of the third rotation member 130 while the rotation members 110, 120, and 130 are rotated.

FIG. 5B illustrates the case in which the third rotation member 130 is rotated in a different direction (direction CW of FIG. 5B) from the first and second rotation members 110 and 120. In this case, the center of rotation (‘\textcircled{x}’ of FIG. 5B) of the main body 10 may be moving while the rotation members 110, 120, and 130 are rotated. However, a speed and a degree by which the center is moved may be larger than in the case in which all of the first, second, and third rotation members 110, 120, and 130 are rotated in the same direction.

According to such a principle, the controller 170 may control at least one of the rotation direction or the rotation speed of the third rotation member 130 to adjust a travel direction of the robot cleaner 100.

The detector 145 may include a measurement unit (not shown) for measuring at least one of an acceleration and an angular speed of the robot cleaner 10. In more detail, the detector 145 may include an inertial measurement unit (IMU) (not shown). The IMU (not shown) may refer to a device for measuring the speed, direction, gravity, and acceleration of a moving object based on a sensor and may have a 3-axis accelerometer and a 3-axis angular speedometer installed therein.

The controller 170 may control at least one of the rotation direction or the rotation speed of the third rotation member 130 based on at least one of an acceleration or an angular speed of the robot cleaner 100 detected by the measurement unit (not shown) to adjust a travel direction of the robot cleaner 100.

According to an embodiment of the present disclosure, the controller 170 may detect a variation of the center of rotation of the main body 10 using a detection value of the inertial measurement unit (not shown) and may control the driver 150 to change the rotation speed of the third rotation member 130 and to fix the center of rotation at a predetermined position or may control the driver 150 to move the center of rotation to follow a specific trajectory based on the detected variation.

When the robot cleaner 100 is rotated on the spot, the center of rotation and the center of the main body 10 may be maintained to match each other by detecting a rotation angle of the main body 10 and variation in the center of rotation based on a measured value of the inertial measurement unit (not shown) and increasing and reducing the speed of the third rotation member 130 when the center of rotation of the main body 10 moves off the center of the main body 10.

The controller 170 may control at least one of the rotation direction or the rotation speed of the third rotation member 130 based on information on a load applied to at least one of the first rotation member 110 or the second rotation member 120.

The load may be the reason for friction between the cleaning target surface 900 and the cleaners 210 and 220 that are fixed to the first and second rotation members 110 and 120, respectively, due to rotation of the first and second rotation members 110 and 120. In particular, when a coefficient of friction of the cleaning target surface 900 is changed because the cleaning target surface 900 is inclined or uneven, the load may be increased or reduced.

The load may also be generated for other reasons related to the operation state or performance of instruments of the robot cleaner 100.

When a load applied to each of the first and second rotation members 110 and 120 is not uniform, performance for controlling the rotation speeds of the first and second rotation members 110 and 120 may be lowered. This may cause a problem in that the robot cleaner 100 does not follow a travel path and does not appropriately travel straight or moves off a cleaning area.

When a load applied to any one of the first and second rotation members 110 and 120 is excessive, a serious problem may arise in feedback control of a rotation speed (revolutions-per-minute (RPM)) and vibration of rotation speed may occur. Extremely, there is a risk that a lifespan of a motor of the driver 150 is reduced or the motor is damaged.

Thus, when the non-uniform load or the excessive load is prevented from being generated, this may provide help improving the travelling and cleaning performance of the robot cleaner 100.

According to an embodiment of the present disclosure, information on the applied load may be acquired from a control value input to the rotation motor (not shown) included in the driver 150 and generating power for rotating the first and second rotation members 110 and 120. According to an embodiment of the present disclosure, the control value may be a duty rate of a PWM signal. Alternatively, the control value may be a variable voltage value.

According to another embodiment of the present disclosure, the information on the applied load may be acquired from a current or power value output from the rotation motor (not shown) or a driving circuit thereof.

According to another embodiment of the present disclosure, the information on the applied load may be acquired through a calculating procedure from an acceleration and an angular speed measured by the inertial measurement unit (not shown) and revolutions-per-minute (RPM)(rotation speed) of the first and second rotation members 110 and 120. That is, it may be possible to calculate the load in an actual travel environment based on a table or a formula which matches the revolutions-per-minute (RPM)(rotation speed) of the first and second rotation members 110 and 120 with the acceleration and angular speed of the first rotation member 110 in various load experimental conditions.

In order to embody the aforementioned various embodiments, the detector 145 may include at least one of an inertial measurement unit (not shown) for measuring an acceleration and an angular speed, an encoder for detecting the revolutions-per-minute (RPM) of the first and second rotation members 110 and 120 or rotation motors (not shown) corresponding thereto, or a detection device for detecting an input control value or output current (power) of the rotation motors (not shown).

The controller 170 may determine a rotation direction of the third rotation member 130 as a direction in which a value of a load applied to a rotation member having a greater difference obtained by subtracting a reference value from the value of the applied load than the other rotation member is reduced among the first rotation member 110 and the second rotation member 120.

The rotation speed of the third rotation member 130 may be determined based on the amplitudes of the differences.

As such, the non-uniformity of the load applied to the first and second rotation members 110 and 120 may be overcome and the performance for controlling the rotation speed may be improved by determining the rotation direction and rotation speed of the third rotation member 130 based on the amplitudes of the differences.

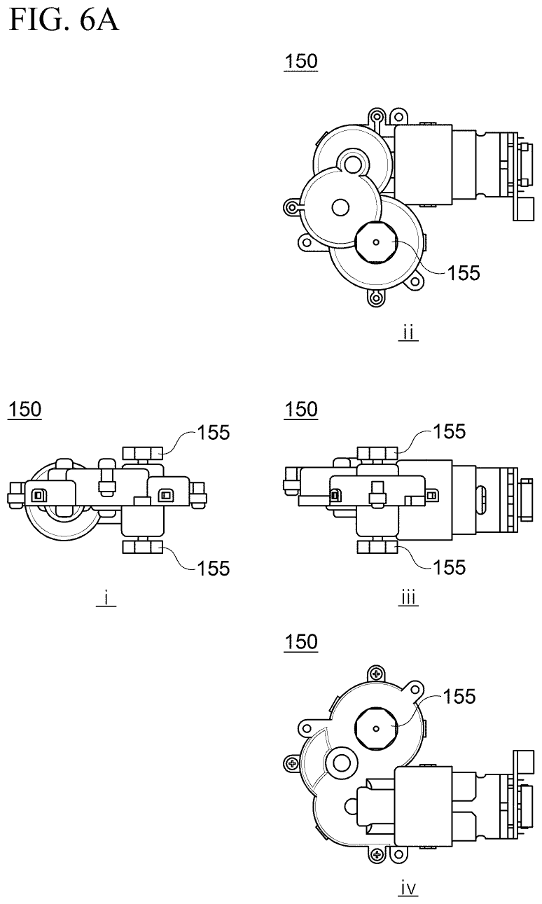

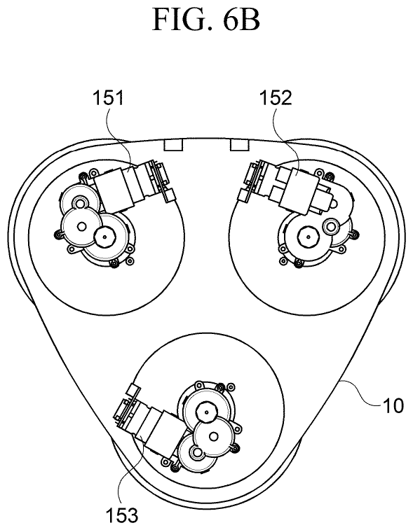

FIGS. 6A and 6B are a set of diagrams showing an outer appearance and arrangement of a driver of a robot cleaner according to an embodiment of the present disclosure.

In more detail, FIG. 6A is a diagram showing the outer appearance of the driver 150, and in this case, i is a left side view, ii is a plan view, iii is a front view, and iv is a bottom view.

As shown in i and iii of FIG. 6A, the driver 150 may include clutches 155 as one component disposed above and below the same and transferring power to the rotation members 110, 120, and 130. Thus, in an inverse structure, the driver 150 according to an embodiment of the present disclosure may also transfer power to the rotation members 110, 120, and 130.

FIG. 6B is a diagram showing the state in which the first driver 151, the second driver 152, and the third driver 153 included in the driver 150 are arranged on the main body 10. As shown in FIG. 6B, one of the first driver 151, the second driver 152, and the third driver 153 may be configured by inverting the others and may be installed in the main body 10.

Through this installation structure, it may be possible to ensure a wide space of other functional units on a central side of the main body 10. Thus, it may be possible to design a slim outer appearance of the main body 10 or to obtain a structure that is easily disassembled and assembled for maintenance.

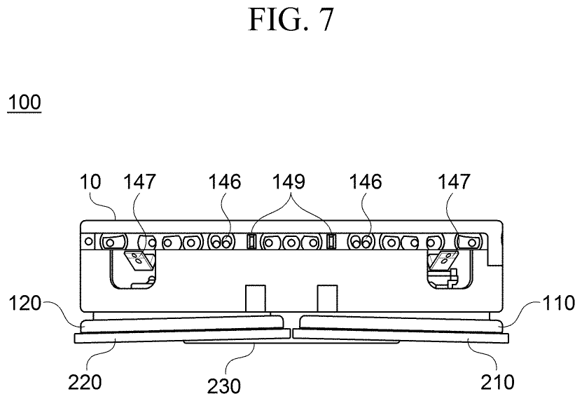

FIG. 7 is a diagram showing the arrangement of a detector of a robot cleaner according to an embodiment of the present disclosure.

The detector 145 may be included in the main body 10. In addition, the detector may detect the state in which the robot cleaner 100 is adjacent to an external object.

In more detail, the detector 145 may include a sensor for detecting the distance from an object positioned at at least one of a forward side, a lateral side, an upward side, or a downward side of the robot cleaner 100.

A sensor (not shown) for detecting the forward side may detect a forward obstacle. In some embodiments, the sensor may be an infrared ray (IR) sensor. However, the present disclosure is not limited thereto, and in some embodiments, the sensor may be embodied as various sensors such as an ultrasonic sensor or a laser sensor.

A sensor 146 for detecting the upward side may detect an upward obstacle. In some embodiments, the sensor 146 may be an IR sensor. However, the present disclosure is not limited thereto, and in some embodiments, the sensor 146 may be embodied as various sensors such as an ultrasonic sensor or a laser sensor.

The aforementioned IR sensor may detect whether an obstacle is present or not in a region in which TX and RX overlap each other.

A sensor 147 for detecting the downward side may detect a drop zone 810. According to an embodiment of the present disclosure, the sensor 147 may be a time-of-flight (ToF) sensor. The ToF may refer to a technology for calculating a distance by measuring the time that light emitted toward an object from a light source is reflected back.

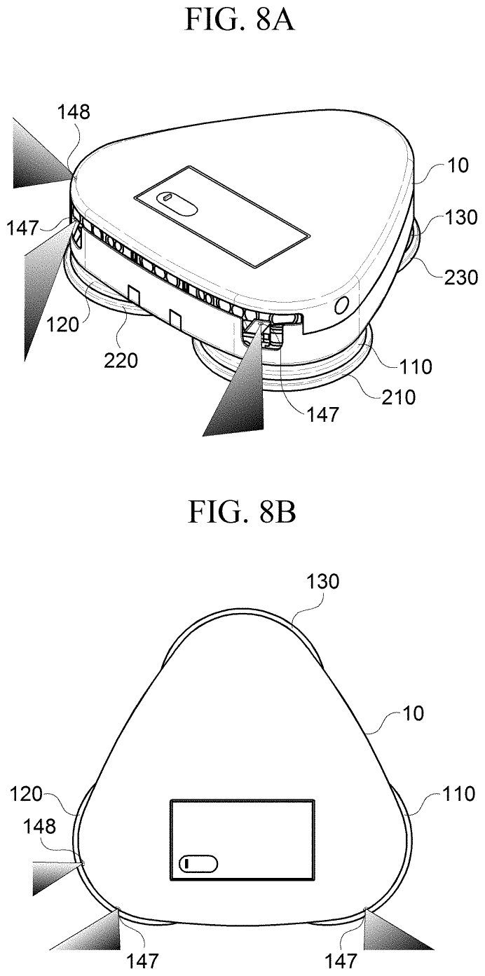

FIGS. 8A and 8B is a set of diagrams showing an operation of a detector of a robot cleaner according to an embodiment of the present disclosure. As shown in FIGS. 8A and 8B, according to an embodiment of the present disclosure, the sensors 147 for detecting the downward side may be disposed downwards at opposite right and left regions of a front surface of the main body 10 of the robot cleaner 100 to unequally distribute the detection directions of the sensors 147 in right and left outward directions at a predetermined angle, thereby effectively detecting the drop zone 810. The predetermined angle may be selected in the range between 20 and 45 degrees. In detail, the predetermined angle may be 30 degrees.

A sensor 148 for detecting the lateral side may detect whether the robot cleaner 100 goes through an obstacle while the robot cleaner 100 travels along a wall and travels to avoid a forward obstacle. According to an embodiment of the present disclosure, the sensor 148 may be a time-of-flight (ToF) sensor.

As shown in FIGS. 8A and 8B, according to an embodiment, the sensors for detecting the lateral sides may be installed at at least one of left and right surfaces of the main body 10 of the robot cleaner 100 to unequally distribute the detection directions of the sensors 147 in a forward direction of the robot cleaner 100 at a predetermined angle. The predetermined angle may be selected in the range between 10 and 20 degrees. In detail, the predetermined angle may be 15 degrees.

The sensor for detecting the lateral side may be installed to the right of the main body 10 when a wall is positioned to the right of the robot cleaner 100 while the robot cleaner 100 travels along the wall.

The detector 145 may include a receiver 149 for receiving a wireless signal transmitted from the external charger (cradle) 191. The receiver 149 may be installed in the main body 10 at the same height as a transmitter (not shown) of the external charger 191. The receiver 149 may be installed at at least one of a front surface, right and left lateral surfaces, or a rear surface of the main body 10 and may detect that the robot cleaner 100 reaches the position at which the robot cleaner 100 is capable of docking on the wireless charger.

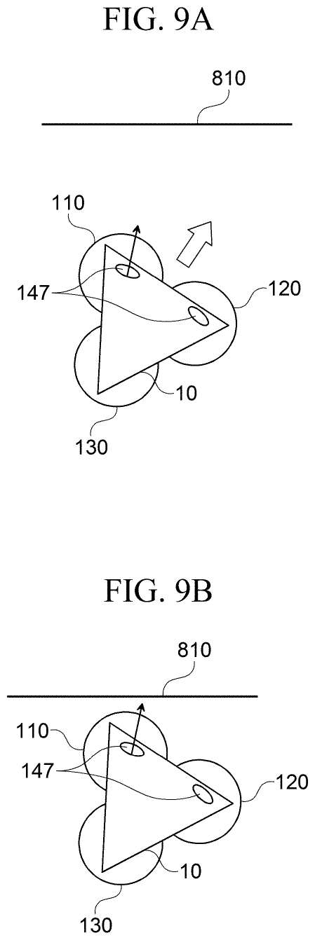

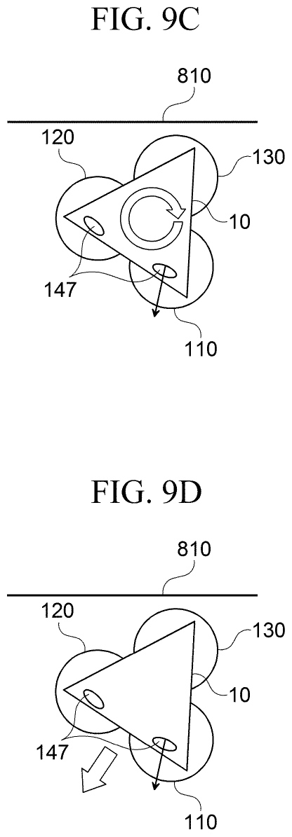

FIGS. 9A-9D are a set of diagrams showing an operation of avoiding a drop zone of a robot cleaner according to an embodiment of the present disclosure.

The controller 170 may control at least one of the rotation direction or the rotation speed of the third rotation member 130 to rotate the robot cleaner 100 on the spot (refer to FIG. 9C) when the detector 145 detects that the state in which the robot cleaner 100 is adjacent to the drop zone 810 (refer to FIG. 9B) while traveling in a specific travel direction (refer to FIG. 9A). Then, the controller 170 may control the robot cleaner 100 to travel forward from the changed position.

As such, when the robot cleaner 100 reaches the drop zone, the robot cleaner 100 may be rotated to change a travel direction. In this case, when a radius of rotation is large, there is the concern about a drop accident of the robot cleaner. Thus, the controller 170 may control at least one of the rotation direction or the rotation speed of the third rotation member 130 to rotate the robot cleaner 100 on the spot.

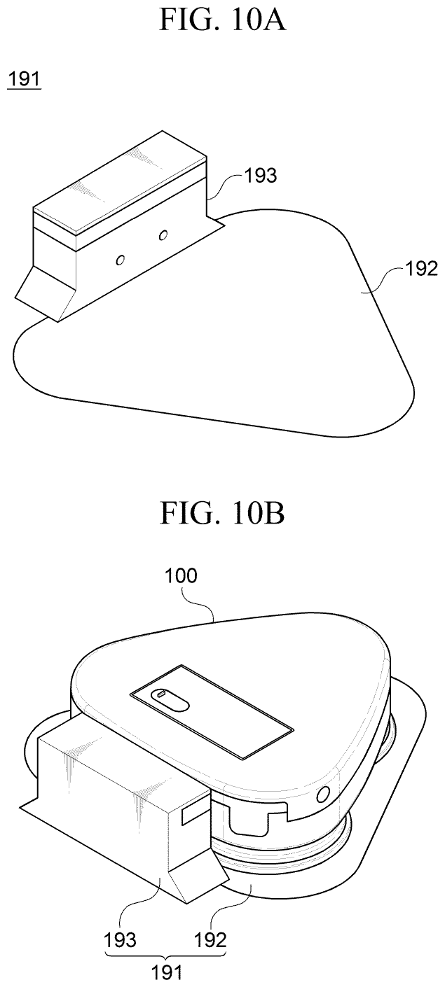

FIGS. 10A and 10B are a set of diagrams showing an external charger and a charging operation thereof according to an embodiment of the present disclosure.

The controller 170 may control at least one of the rotation direction or the rotation speed of the third rotation member 130 to rotate the robot cleaner 100 on the spot when the detector 145 detects the state in which the robot cleaner 100 is adjacent to the external charger 191 (refer to FIG. 10A) that supplies power to the robot cleaner 100 while traveling in a specific travel direction. Then, the controller 170 may perform control to direct an electrode 192 of the power supply 190, formed on a front side of the robot cleaner 100, toward the external charger 191, may control the robot cleaner 100 to travel, and may dock the electrode 192 on the external charger 191 (refer to FIG. 10B).

As shown in FIGS. 10A and 10B, the external charger 191 may include a plate 192 configured to support a bottom surface of at least one of the rotation member 110, 120, or 130 of the main body 10 while the robot cleaner 100 accesses the external charger 191 and is charged.

In detail, the plate 192 may support bottom surfaces of all of the rotation members 110, 120, and 130 during charging.

Through this configuration of the plate 192, the robot cleaner 100 may be charged without the concern about damage of a floor corresponding to a cleaning target surface even if the floor is formed of a material vulnerable to exposure of moisture for a long time, such as wood.

According to an embodiment, the plate 192 may be detachably installed from a main body portion 193 of the external charger.

According to an embodiment, the plate 192 may be configured in the form of a thin film. As such, the robot cleaner 10 may be easily accommodated on an upper surface of the plate 192 through travel using the rotation members 110, 120, and 130 to which the cleaners 210, 220, and 230 are fixed, respectively without a separate component such as a wheel.

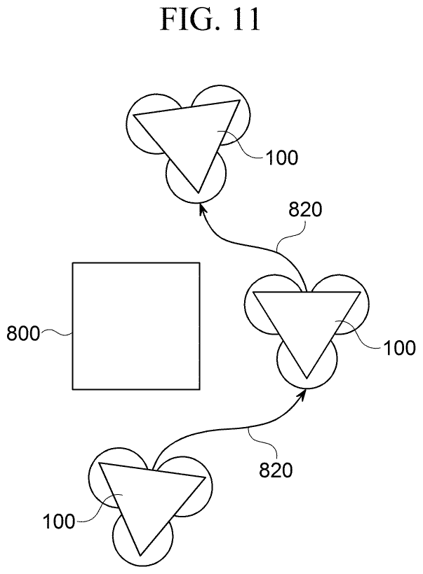

FIG. 11 is a diagram showing an operation of avoiding an obstacle of a robot cleaner according to an embodiment of the present disclosure.

When the detector 145 detects the state in which the robot cleaner 100 is adjacent to an obstacle 800, the controller 170 may control at least one of the rotation direction or the rotation speed of the third rotation member 130 to allow the robot cleaner 100 to travel along a trajectory 820 containing a curve having a predetermined radius of curvature and to avoid the obstacle 800 and the predetermined radius of curvature may be set based on the structural material-property such as the volume or the mass of the robot cleaner 100 or the specification of the rotation motor (not shown) of the driver 150 to prevent a travel speed of the robot cleaner 100 from being lowered or to minimize the travel speed.

As such, it may be possible to avoid the obstacle 800 using a smooth travel trajectory upon detecting the obstacle 800 in front of the robot cleaner 100.

According to an embodiment, the second rotation member 120 may be controlled to rotate at speed x, the first rotation member 110 may be controlled to decelerate to rotation speed bx (0<b<0.5), and the third rotation member 130 may be controlled to rotate in the same direction as the second rotation member 120 at speed (b+0.5), thereby generating a smooth avoidance trajectory using sway of the robot cleaner 100. In this case, it may be possible to realize dynamic movements that are not mechanically visible. The value 0.5 may not be absolutely unchangeable and may be changed and set to any one of values less than 1.

For reference, a conventional robot cleaner avoids an object by decelerating the robot cleaner from a first position at which the obstacle is detected during travel to a second position at which the robot cleaner is more adjacent to the obstacle, stopping the robot cleaner, and then rotating the robot cleaner on the spot (evasion travel).

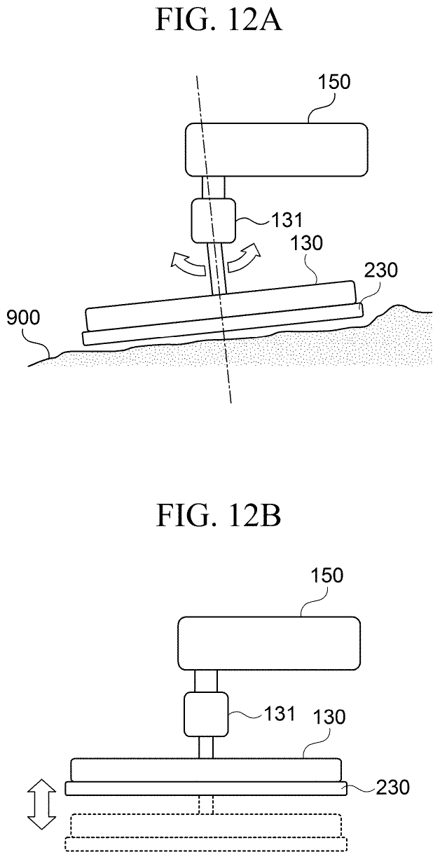

FIGS. 12A and 12B are a set of diagrams showing an operation of a third rotation member according to an embodiment of the present disclosure.

As shown in FIG. 12A, an angle between the third rotation axis 330 of the robot cleaner 100 and a perpendicular axis of the robot cleaner 100 may be changed in response to the shape of the cleaning target surface 900 while the robot cleaner 100 travels.

According to an embodiment of the present disclosure, the third rotation member 130 may include a power transfer member 131 including a universal joint (not shown) or a flexible material to be bent.

As shown in FIG. 12B, the third rotation member 130 may slide in a direction parallel to the perpendicular axis of the robot cleaner 100. According to an embodiment, the power transfer member 131 having a piston-cylinder (not shown) or a sliding guide structure similar thereto may be employed. In addition, the third rotation member 130 may include a flange (not shown) for limiting relative movement of the piston-cylinder.

It may also be possible to achieve a function of changing an angle of the third rotation axis 330 using the sliding guide structure without the universal joint (not shown). In this case, the sliding guide structure may include the clutches 155 for transferring power and a guide (not shown) that comes into contact with the clutches 155 and is rotatably associated therewith, and may allow the third rotation member 130 to move in a horizontal direction by forming a gap in a horizontal direction between the clutches 155 and an internal wall of the guide.

As such, the third rotation member 130 may be configured to be moved along an inclination of the cleaning target surface 900, and thus friction force may be maintained to be uniformly distributed on an entire surface of the cleaner 230 fixed to the third rotation member 130 and the straight travel characteristics of the robot cleaner 100 may be improved.

According to another embodiment, an angle of the third rotation axis 330 and upper and lower positions of the third rotation member 130 may be relatively permanently or variably fixed to the main body 10. However, in this case, the third rotation axis 330 may be highly affected by a change in the inclination of the cleaning target surface 900, and sway of the robot cleaner 100 may occur while the robot cleaner 100 travels in the rotation direction of the third rotation member 130. On the other hand, in this case, the third rotation axis 330 may be a useful component for reducing a load applied to the first rotation member 110 or the second rotation member 120. In particular, the third rotation axis 330 may more effectively reduce a load of a member rotating in the same direction as that of the third rotation member 130 among the first rotation member 110 and the second rotation member 120.

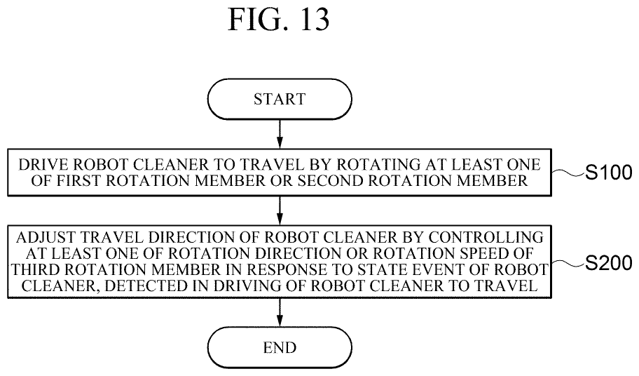

FIG. 13 is a flowchart showing a method of controlling a robot cleaner according to an embodiment of the present disclosure.

As shown in FIG. 13, according to an embodiment of the present disclosure, the method of controlling the robot cleaner 100 using rotary power of a plurality of rotation members to which cleaners for wet cleaning of the cleaning target surface 900 are attachable, as a movement force source for travel, may include driving the robot cleaner 100 to travel by rotating at least one of the first rotation member 110 rotating around the first rotation axis 310 or the second rotation member 120 rotating around the second rotation axis 320 (S100).

The driving of the robot cleaner 100 to travel may include adjusting a travel direction of the robot cleaner 100 by controlling at least one of a rotation direction or a rotation speed of the third rotation member 130 rotating around the third rotation axis 330 in response to a state event of the robot cleaner 100, detected in the driving the robot cleaner 100 to travel (S200).

The third rotation axis 330 of the robot cleaner 100 according to an embodiment of the present disclosure may be positioned parallel to a perpendicular direction of the robot cleaner 100.

According to an embodiment of the present disclosure, a surface of the third rotation member 130, to which the cleaner 230 is fixed, may be positioned parallel to the cleaning target surface 900 while the robot cleaner 100 travels.

The driving the robot cleaner 100 to travel (S100) may include detecting a load applied to at least one of the first rotation member 110 or the second rotation member 120 (S110).

In the adjusting the travel direction (S200), at least one of the rotation direction or the rotation speed of the third rotation member 130 may be controlled to restore the detected load to an acceptance range when an event in which the detected load gets out of the acceptable range occurs.

The driving the robot cleaner 100 to travel (S100) may include detecting the state in which the robot cleaner 100 is adjacent to an external object (S120).

In the adjusting the travel direction (S200), at least one of the rotation direction or the rotation speed of the third rotation member 130 may be controlled to rotate the robot cleaner 100 on the spot when an event of detecting the state in which the robot cleaner 100 is adjacent to the drop zone 810 or the external charger 191 for supplying power to the robot cleaner 100 occurs in the detecting the state.

The driving the robot cleaner 100 to travel (S100) may include detecting the state in which the robot cleaner 100 is adjacent to an external object (S120).

When the event of detecting the state in which the robot cleaner 100 is adjacent to the obstacle 800 occurs in the detecting the state (S120), at least one of the rotation direction or the rotation speed of the third rotation member 130 may be controlled to drive the robot cleaner 100 and to avoid the obstacle 800 along the trajectory 820 containing a curve having a predetermined radius of curvature.

According to the aforementioned various embodiments of the present disclosure, the robot cleaner may travel while performing wet cleaning using rotary power of the plurality of rotation members as a movement force source.

According to the various embodiments of the present disclosure, the robot cleaner may use rotary power of the plurality of rotation members as a movement force source, thereby improving battery efficiency.

According to the various embodiments of the present disclosure, the robot cleaner may include three rotation members to remove a dead zone of cleaning.

According to the various embodiments of the present disclosure, the robot cleaner may use one of the three rotation members as a device for determining a travel direction, and thus may specify and perform an effective corresponding operation in response to a situation that occurs during travel.

The aforementioned control method according to various embodiments of the present disclosure may be embodied in a program code and may be provided in each server or devices while being stored in various non-transitory computer readable media.

The non-transitory computer readable medium is a medium that semi-permanently stores data and from which data is readable by a device, but not a medium that stores data for a short time, such as a register, a cache, a memory, and the like. In detail, the aforementioned various applications or programs may be stored in the non-transitory computer readable medium, for example, a compact disk (CD), a digital versatile disk (DVD), a hard disk, a Blu-ray disk, a universal serial bus (USB), a memory card, a read only memory (ROM), and the like, and may be provided.

The above-mentioned detailed description is to be interpreted as being illustrative rather than being restrictive in all aspects. The scope of the present disclosure should be determined by a rational interpretation of the appended claims, and all changes within the equivalent scope of the present disclosure are included in the scope of the present disclosure.

1. A robot cleaner comprising:
a main body;
a driver included in the main body and supplying power for driving the robot cleaner to travel;
first, second, and third rotation members that are rotated around first, second, and third rotation axes, respectively, using power of the driver and to which cleaners for wet cleaning of a cleaning target surface are fixedly installed, respectively; and
a controller controlling at least one of a rotation direction or a rotation speed of the third rotation member to adjust a travel direction of the robot cleaner,
wherein the third rotation axis is parallel to a perpendicular direction of the robot cleaner.

2. The robot cleaner of claim 1, wherein the first and second rotation axes are inclined at a predetermined angle with respect to a central axis parallel to a perpendicular axis of the robot cleaner to externally incline the first and second rotation members in a downward direction based on the central axis.

3. The robot cleaner of claim 2, wherein, when the cleaners for wet cleaning are fixed to the first and second rotation members, respectively, the robot cleaner travels using friction force between each of the fixed cleaners and the cleaning target surface, which is generated due to a rotary motion of each of the fixed cleaners, as a movement force source.

4. The robot cleaner of claim 2, wherein the first rotation axis and the second rotation axis are symmetrical to each other with respect to a first plane containing the central axis, and the third rotation axis is contained in the first plane.

5. The robot cleaner of claim 1, wherein the controller controls at least one of the rotation direction or the rotation speed of the third rotation member based on information on a load applied to at least one of the first and second rotation members.

6. The robot cleaner of claim 5, wherein the controller determines a rotation direction of the third rotation member as a direction in which a value of a load applied to a rotation member having a greater difference obtained by subtracting a reference value from the value of the applied load than a remaining rotation member is reduced among the first and second rotation members.

7. The robot cleaner of claim 1, further comprising a detector included in the main body and detecting a state in which the robot cleaner is adjacent to an external object.

8. The robot cleaner of claim 7, wherein, when the detector detects a state in which the robot cleaner is adjacent to a drop zone or an external charger supplying power to the robot cleaner, the controller controls at least one of the rotation direction or the rotation speed of the third rotation member to rotate the robot cleaner on the spot.

9. The robot cleaner of claim 7, wherein, when the detector detects a state in which the robot cleaner is adjacent to an obstacle, the controller controls at least one of the rotation direction or the rotation speed of the third rotation member to allow the robot cleaner to travel along a trajectory containing a curve having a predetermined radius of curvature and to avoid the obstacle.

10. A robot cleaner comprising:
a main body;
a driver included in the main body and supplying power for driving the robot cleaner to travel;
first, second, and third rotation members that are rotated around first, second, and third rotation axes, respectively, using power of the driver and to which cleaners for wet cleaning of a cleaning target surface are fixedly installed, respectively; and
a controller controlling the driver to adjust a travel direction of the robot cleaner,
wherein an angle between the third rotation axis and a perpendicular axis of the robot cleaner is changed in response to a shape of the cleaning target surface while the robot cleaner travels.

11. The robot cleaner of claim 10, wherein the first and second rotation axes are inclined at a predetermined angle with respect to a central axis parallel to the perpendicular axis of the robot cleaner to externally incline the first and second rotation members in a downward direction based on the central axis.

12. The robot cleaner of claim 10, wherein the third rotation member is capable of sliding parallel to a perpendicular direction of the robot cleaner.

13. The robot cleaner of claim 11, wherein the third rotation member is capable of sliding parallel to a perpendicular direction of the robot cleaner.

14. The robot cleaner of claim 10, wherein the controller controls at least one of the rotation direction or the rotation speed of the third rotation member based on information on a load applied to at least one of the first rotation member or the second rotation member.

15. The robot cleaner of claim 10, further comprising a detector included in the main body and detecting a state in which the robot cleaner is adjacent to an external object,
wherein, when the detector detects a state in which the robot cleaner is adjacent to a drop zone or an external charger supplying power to the robot cleaner, the controller controls at least one of the rotation direction or the rotation speed of the third rotation member to rotate the robot cleaner on the spot.

16. A method of controlling a robot cleaner using rotary power of a plurality of rotation members to which cleaners for wet cleaning of a cleaning target surface are attachable, as a movement force source for travel, the method comprising:
driving the robot cleaner to travel by rotating at least one of a first rotation member rotating around a first rotation axis or a second rotation member rotating around a second rotation axis; and
adjusting a travel direction of the robot cleaner by controlling at least one of a rotation direction or a rotation speed of a third rotation member rotating around a third rotation axis in response to a state event of the robot cleaner, detected in the driving the robot cleaner to travel,
wherein the third rotation axis is parallel to a perpendicular direction of the robot cleaner, or a surface of the third rotation member, to which the cleaner is fixed, is parallel to the cleaning target surface while the robot cleaner travels.

17. The method of claim 16, wherein the driving the robot cleaner to travel includes detecting a load applied to at least one of the first rotation member or the second rotation member, and
wherein the adjusting the travel direction includes controlling at least one of the rotation direction or the rotation speed of the third rotation member to restore the detected load to an acceptance range when an event in which the detected load gets out of the acceptance range occurs.

18. The method of claim 17, wherein the driving the robot cleaner to travel includes detecting a state in which the robot cleaner is adjacent to an external object, and
wherein the adjusting the travel direction includes controlling at least one of the rotation direction or the rotation speed of the third rotation member to rotate the robot cleaner on the spot when an event of detecting a state in which the robot cleaner is adjacent to a drop zone or an external charger supplying power to the robot cleaner occurs in the detecting the state.

19. The method of claim 17, wherein the driving the robot cleaner to travel includes detecting a state in which the robot cleaner is adjacent to an external object, and
wherein, when an event of detecting a state in which the robot cleaner is adjacent to an obstacle in the detecting the state occurs, at least one of the rotation direction or the rotation speed of the third rotation member is controlled to allow the robot cleaner to travel along a trajectory containing a curve having a predetermined radius of curvature and to avoid the obstacle.
